(19) United States
(12) Patent Application Publication
(10) Pub. No.: US 2024/0214127 A1
(43) Pub. Date: Jun. 27, 2024

(54) METHOD FOR DATA TRANSMISSION, TERMINAL DEVICE, AND COMPUTER STORAGE MEDIUM

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN); Zhe FU, Dongguan (CN)

(73) Assignee: GUANGDONG OPPO MOBILE TELECOMMUNICATIONS CORP., LTD., Dongguan (CN)

(21) Appl. No.: 18/434,572

(22) Filed: Feb. 6, 2024

Related U.S. Application Data
(63) Continuation of application No. PCT/CN2021/127933, filed on Nov. 1, 2021.

(51) Int. Cl. H04L 1/1812; H04L 1/1867

(52) U.S. Cl. CPC H04L 1/1816; H04L 1/1887

(57) ABSTRACT

A method for data transmission, a terminal device, and a computer storage medium are provided. The method includes that: determining a target SSB, and retransmitting first data to a network device by using a CG resource associated with the target SSB.

### CROSS-REFERENCE TO RELATED APPLICATION

This is a continuation of International Patent Application No. PCT/CN2021/127933, filed on Nov. 1, 2021, the disclosure of which is hereby incorporated by reference in its entirety.

### BACKGROUND

In a communication system, a technology called Early Data Transmission (EDT) may realize transmission for small and micro data packets (blocks), that is, Small Data Transmission (SDT). The small data transmission may be implemented based on the following two mechanisms: a pre-configured transmission resource (PUR Based RRC_INACTIVE) for data transmission and a dynamically allocated resource (4/2-step, RACH Based RRC_INACTIVE) for data transmission. For the pre-configured transmission resource (PUR Based RRC_INACTIVE) for data transmission, a terminal device may retransmit data based on a dynamic scheduling by a network side.

### SUMMARY

The disclosure relates to the field of communication technologies, and more particularly to a method for data transmission, a terminal device, and a non-transitory computer storage medium.

In a first aspect, an embodiment of the disclosure provides a method for data transmission, which includes the following operations.

A target Synchronization Signal Block (SSB) is determined.

First data is retransmitted to a network device using a Configured Grant (CG) resource associated with the target SSB.

In a second aspect, an embodiment of the disclosure provides a terminal device, which includes a processor, a memory and a transceiver, and the processor is coupled to the memory and the transceiver. The memory is configured to store instructions. The processor is configured to: determine a target SSB, and control the transceiver to retransmit first data to a network device using a CG resource associated with the target SSB.

In a third aspect, an embodiment of the disclosure provides a non-transitory computer storage medium. The computer storage medium has stored thereon computer programs or instructions that, when executed by a processor, causes the processor to perform the method for data transmission in the first aspect.

### BRIEF DESCRIPTION OF THE DRAWINGS

The following will provide a brief introduction to the drawings required in the descriptions of the embodiments or the related art.

FIG. 1 is a framework diagram of a communication system according to an embodiment of the disclosure.

FIG. 2 is a schematic diagram illustrating uplink small data transmission based on a pre-configured resource according to an embodiment of the disclosure.

FIG. 3 is a flowchart illustrating a method for data transmission according to an embodiment of the disclosure.

FIG. 4 is a flowchart illustrating a method for data transmission according to another embodiment of the disclosure.

FIG. 5 is a flowchart illustrating a method for data transmission according to yet another embodiment of the disclosure.

FIG. 6 is a flowchart illustrating a method for data transmission according to still another embodiment of the disclosure.

FIG. 7 is a schematic diagram illustrating data transmission according to an embodiment of the disclosure.

FIG. 8 is a structural diagram of a terminal device according to an embodiment of the disclosure.

FIG. 9 is a structural diagram of a terminal device according to another embodiment of the disclosure.

### DETAILED DESCRIPTION

The technical solutions in the embodiments of the disclosure will be described below in combination with the drawings.

The technical solutions in the embodiments of the disclosure may be applied to various communication systems, for example, a Long Term Evolution (LTE) system, an LTE Frequency Division Duplex (FDD) system, an LTE Time Division Duplex (TDD) system, an Advanced long term evolution (LTE-A) system, a New Radio (NR) system, an evolved NR system, an LTE-based access to unlicensed spectrum (LTE-U) system, an NR-based access to unlicensed spectrum (NR-U) system, a Multiple-Input Multiple-Output (MIMO) system, a Wireless Local Area Network (WLAN), a Wireless Fidelity (WiFi), a next generation communication system or other communication systems.

In general, a traditional communication system supports a limited number of connections and is easy to implement. However, with the development of communication technologies, a mobile communication system will not only support the traditional communication, but also support, for example, a Device to Device (D2D) communication, a Machine to Machine (M2M) communication, a Machine Type Communication (MTC), a Vehicle to Vehicle (V2V) communication, etc. The embodiments of the disclosure may also be applied to these communication systems.

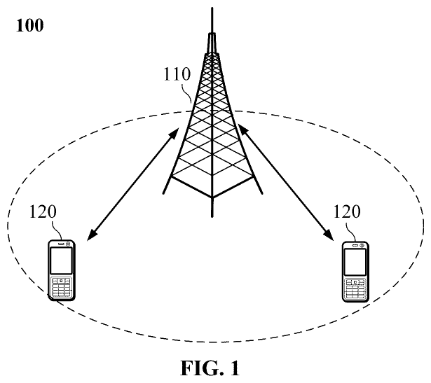

Illustratively, a communication system 100 to which the embodiments of the disclosure are applied is illustrated in FIG. 1. The communication system 100 may include a network device 110, and the network device 110 may be a device that communicates with a terminal device 120 (or referred to as a communication terminal or a terminal). The network device 110 may provide communication coverage for a specific geographic area and may communicate with terminal devices located in the coverage area. Optionally, the network device 110 may be an Evolutional Node B, (eNB or eNode B) in an LTE system, or a wireless controller in a Cloud Radio Access Network (CRAN). The network device may further be a mobile switching center, a relay station, an access point, a vehicle-mounted device, a wearable device, a hub, a switch, a bridge, a router, a network-side device in a 5th Generation (5G) network, or a network device in a future evolved communication system, etc.

The communication system 100 also includes at least one terminal device 120 located in the coverage area of the network device 110. The terminal device 120 may be connected to the network device 110 in a wireless or wired manner. When the terminal device 120 is wirelessly connected to the network device 110, the terminal device 120 may be referred to as a “wireless communication terminal”, a “wireless terminal” or a “mobile terminal”. An example of the mobile terminal includes, but is not limited to, a satellite or a cellular phone; a Personal Communication System (PCS) terminal that combines a cellular radio telephone with data processing, a fax, and a data communication capacity; a Personal Digital Assistant (PDA) that may include a radio telephone, a pager, an Internet/Intranet access, a Web browser, a notebook, a calendar, and/or a Global Positioning System (GPS) receiver; a conventional laptop and/or handheld receiver, or other electronic devices including a radio telephone transceiver. The terminal device may be referred to as an access terminal, User Equipment (UE), a user unit, a user station, a mobile platform, a remote station, a remote terminal, a mobile device, a user terminal, a terminal, a wireless communication device, a user agent or a user device. The access terminal may be a cellular phone, a cordless phone, a Session Initiation Protocol (SIP) phone, a Wireless Local Loop (WLL) station, a PDA, a handheld device with a wireless communication function, a computing device, another processing device connected to a wireless modem, a vehicle-mounted device, a wearable device, a terminal device in the 5G network, a terminal device in the future evolved communication system and/or the like.

Optionally, the terminal device 120 may perform a D2D communication with another terminal device or UE.

Optionally, the 5G system or 5G network may also be referred to as an NR system or an NR network.

Optionally, FIG. 1 exemplarily illustrates one network device and two terminal devices. Optionally, the communication system 100 may include multiple network devices and another number of terminal devices may be included in coverage of each network device, which is not limited in the embodiments of the disclosure.

Optionally, the communication system 100 may further include a network controller, a mobility management entity and other network entities, which are not limited in the embodiments of the disclosure.

It should be understood that the terms “system” and “network” used herein are often used interchangeably. Herein, the term “and/or” is only an association relationship that describes associated objects and represents that three relationships may exist. For example, A and/or B may represent three conditions: independent existence of A, existence of both A and B and independent existence of B. In addition, character “/” used herein usually represents that the associated objects before and after the character “/” form an “or” relationship.

In an embodiment of the disclosure, the terminal device will release a Radio Bearer (RB) and all radio resources in a Radio Resource Control_INACTIVE (RRC_INACTIVE) state, but the terminal device side and the network device side retain an access context of the terminal device to quickly restore the Radio Resource Control (RRC) connection. The network device usually keeps the terminal device with infrequent data transmission in the RRC_INACTIVE state. LTE Release 17 initiated a research on Small Data Transmission (SDT) in the RRC_INACTIVE state. The SDT may be implemented based on the following two mechanisms: a pre-configured transmission resource (PUR Based RRC_INACTIVE) for data transmission (i.e., an uplink small data transmission based on the pre-configured resource) and a dynamically allocated resource (4/2-step, RACH Based RRC_INACTIVE) for data transmission (i.e., an uplink small data transmission based on a two-step/four-step random access procedure).

The pre-configured transmission resource (PUR Based RRC_INACTIVE) for data transmission means that: the terminal device performs data transmission based on a pre-configured Uplink Resource (PUR) in the RRC_INACTIVE state. The PUR may include a Configured Grant (CG) resource, for example, CG type 1, CG type 2, and so on.

The dynamically allocated resource (4/2-step RACH Based RRC_INACTIVE) for data transmission means that: the terminal device performs data transmission based on a two-step/four-step Random Access Channel (RACH) in the RRC_INACTIVE state.

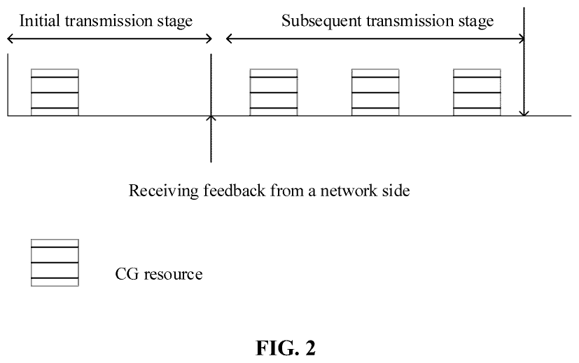

Further, the uplink small data transmission based on the pre-configured resource may also be referred to as CG-SDT, and the transmission process of CG-SDT may be divided into two stages, namely an initial transmission stage and a subsequent transmission stage. For example, FIG. 2 illustrates a schematic diagram of the uplink small data transmission based on the pre-configured resource. The initial transmission stage refers to that: the terminal device preforms a first uplink data transmission using a CG resource during the SDT. The subsequent transmission stage refers to that: after the terminal device successfully completes the first uplink data transmission, the terminal device continues to perform uplink data transmission during the SDT without changing a terminal state, that is, the terminal device remains in RRC_INACTIVE state. In the subsequent transmission stage, the terminal may transmit data based on the CG resource or a Dynamic Grant (DG) resource.

In the traditional communication system, the terminal device may retransmit data based on a dynamic scheduling by the network side, which leads to low reliability of data retransmission.

In view of the above problems, the disclosure proposes the following embodiments, which will be described in detail below with reference to the drawings.

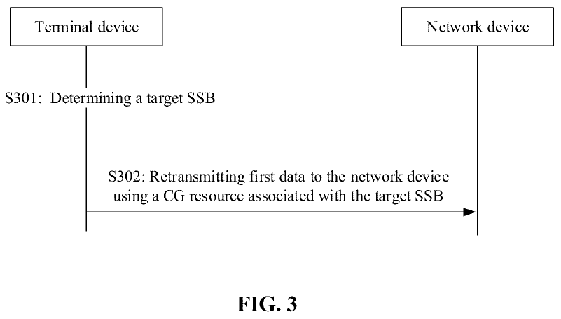

With reference to FIG. 3, FIG. 3 is a flowchart illustrating a method for data transmission according to an embodiment of the disclosure, which is applied to the above-mentioned exemplary communication system. The method includes the following operations.

At operation S301, a terminal device determines a target SSB.

For example, in the CG-SDT process, the terminal device may initially transmit first data using a first CG resource associated with a first SSB. A Hybrid Automatic Repeat reQuest (HARQ) process corresponding to the first CG resource is a first HARQ process. Specifically, before transmitting the first data to a network device, the terminal device may determine whether an SSB is present that satisfies a pre-configured threshold and is configured with a CG resource. The pre-configured threshold may be a Reference Signal Received Power (RSRP) threshold, and satisfying the pre-configured threshold may refer to exceeding the pre-configured threshold. In response to a presence of the SSB, the terminal device may transmit the first data to the network device using a CG resource corresponding to the first HARQ process in one or more CG resources associated with the SSB. Optionally, assuming that the first SSB satisfies the pre-configured threshold and is configured with the CG resource, the terminal device may transmit the first data to the network device using the first CG resource corresponding to the first HARQ process in the one or more CG resources associated with the first SSB. The number of CG resources associated with the first SSB may be one or more, and the one or more CG resources associated with the first SSB may include the first CG resource. If the transmission of the first data fails, the terminal device may retransmit the data. Specifically, the terminal device may determine the target SSB for retransmitting the first data, and then retransmit the first data to the network device using a CG resource associated with the target SSB. The first data refers to any retransmission data to be retransmitted, that is, any small and micro data block (packet) to be retransmitted.

In an embodiment, the terminal device may initially transmit the first data using the first CG resource associated with the first SSB, and the HARQ process corresponding to the first CG resource is the first HARQ process. Therefore, when retransmitting the first data, the terminal device may determine the first SSB as the target SSB.

In another embodiment, in response to second data being transmitted by the terminal device using a CG resource associated with a second SSB before determining the target SSB, the terminal device may determine the second SSB as the target SSB. Otherwise, the terminal device may determine the first SSB as the target SSB. For example, before automatically retransmitting the first data, the terminal device may determine whether the CG resource associated with the second SSB is used to transmit the second data to the network device, and if so, the second SSB is determined as the target SSB; if not, the first SSB is determined as the target SSB. The second SSB is different from the first SSB, and the second data is also different from the first data. Optionally, if the terminal device uses a third CG resource corresponding to a second HARQ process in the CG resources associated with the second SSB for new data transmission before automatically retransmitting the first data, that is, the terminal device transmits the second data to the network device using the third CG resource corresponding to the second HARQ process in the CG resources associated with the second SSB, then the terminal device may automatically retransmit the first data using a second CG resource corresponding to the first HARQ process in the CG resources associated with the second SSB. Otherwise, the terminal device automatically retransmits the first data using a second CG resource corresponding to the first HARQ process in the CG resources associated with the first SSB.

In another embodiment, the terminal device may determine a third SSB that exceeds the pre-configured threshold and is configured with a CG resource, and determines the third SSB as the target SSB. For example, before automatically retransmitting the first data, the terminal device may determine whether the third SSB is present that exceeds the pre-configured threshold and is configured with the CG resource. In response to a presence of the third SSB, the third SSB is determined as the target SSB; and in response to an absence of the third SSB, a first SSB is determines as the target SSB or a random access procedure is initiated. The third SSB may be the same as or different from the first SSB.

At operation S302, the terminal device retransmits first data to a network device using a CG resource associated with the target SSB.

In an embodiment, when the target SSB is the first SSB, the terminal device may retransmit the first data to the network device using the CG resource associated with the first SSB. Specifically, if the terminal device initially transmits the first data to the network device using the first CG resource corresponding to the first HARQ process in the CG resources associated with the first SSB, the terminal device may retransmit the first data to the network device using the second CG resource corresponding to the first HARQ process in the CG resources associated with the first SSB.

In an embodiment, when the target SSB is the second SSB, the terminal device may retransmit the first data to the network device using the CG resource associated with the second SSB. Specifically, if the terminal device initially transmits the second data to the network device using the third CG resource corresponding to the second HARQ process in the CG resources associated with the second SSB, the terminal device may retransmit the first data to the network device using the second CG resource corresponding to the first HARQ process in the CG resources associated with the second SSB.

In an embodiment, when the target SSB is the third SSB, the terminal device may retransmit the first data to the network device using the CG resource associated with the third SSB. Specifically, if the terminal device initially transmits the first data to the network device using the first CG resource corresponding to the first HARQ process in the CG resources associated with the third SSB, the terminal device may retransmit the first data to the network device using the second CG resource corresponding to the first HARQ process in the CG resources associated with the third SSB.

In the embodiments of the disclosure, the reliability of data retransmission may be improved by determining the target SSB for data retransmission and then retransmitting the first data to the network device using the CG resource associated with the determined target SSB.

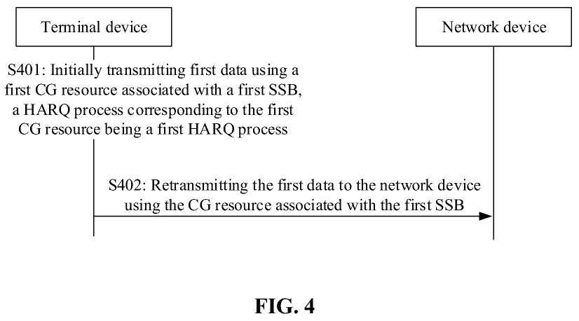

With reference to FIG. 4, FIG. 4 is a flowchart illustrating a method for data transmission according to another embodiment of the disclosure, which is applied to the above-mentioned exemplary communication system. The method includes the following operations.

At operation S401, the terminal device initially transmits the first data using a first CG resource associated with a first SSB, and a HARQ process corresponding to the first CG resource is a first HARQ process.

For example, in the CG-SDT process, assuming that the terminal device transmit the first data to the network device using the first CG resource corresponding to the first HARQ process in the CG resources associated with the first SSB, and if the transmission of the first data fails, the terminal device may retransmit the first data. Specifically, the terminal device may retransmit the first data to the network device using the CG resource associated with the first SSB. In the embodiment of the disclosure, the terminal device does not need to re-evaluate the SSB when retransmitting the first data, that is, the terminal device does not need to determine whether a SSB is present that satisfies the RSRP threshold and is configured with the CG resource, but directly uses the CG resource associated with the first SSB to retransmit the first data to the network device.

In an embodiment, the terminal device in the RRC_INACTIVE state may trigger the CG-SDT process when a trigger condition for the SDT is satisfied. That is, the terminal device may use the first CG resource associated with the first SSB to transmit the first data to the network device when the trigger condition for the SDT is satisfied. The first SSB refers to an SSB that exceeds a pre-configured threshold and is configured with a CG resource.

Specifically, the terminal device in the RRC_INACTIVE state triggers the CG-SDT process when the trigger condition for the SDT is satisfied. The trigger condition for SDT includes one or more of: to-be-transmitted data belonging to a RB that is allowed to trigger the SDT, and a data amount of the to-be-transmitted data is less than or equal to a data amount threshold configured by a network; a RSRP measurement result is greater than or equal to a pre-configured threshold; a CG resource is present on a carrier for transmitting to-be-transmitted data and a CG resource is present on an SSB for transmitting the to-be-transmitted data; or Timing Advance (TA) is a valid TA. The to-be-transmitted data at least includes the first data. Illustratively, when a TA timer (also referred to as a time alignment timer, or TAT for short) is running and/or a change in the RSRP does not exceed the pre-configured threshold, it indicates that the TA is valid.

Further, after the terminal device triggers the CG-SDT, the terminal device may transmit a first message using a CG resource or a dynamic resource scheduled by a network. The first message includes one or more of: an RRC message (e.g., an RRC Resume Request message), terminal data (e.g., user plane data and/or control plane data), or a Medium Access Control Control Element (MAC CE) (e.g., a Buffer Status Report (BSR) MAC CE), etc.

Further, after the first message is successfully transmitted, in response to a present of to-be-transmitted uplink data, the terminal device may select a valid CG resource for uplink data transmission. Illustratively, the to-be-transmitted uplink data may include the first data. Assuming that the valid CG resource is the first CG resource associated with the first SSB, the terminal device may transmit the first data to the network device using the first CG resource associated with the first SSB after the trigger condition for the SDT is satisfied and a transmission of the first message is completed. Optionally, the terminal device may further determine that a first timer for a HARQ process corresponding to the first CG resource associated with the first SSB expires or in a non-running state. That is, after the trigger condition for the SDT is satisfied and the transmission of the first message is completed, if the first timer for the HARQ process corresponding to the first CG resource associated with the first SSB expires or in a non-running state, the terminal device transmits the first data to the network device using the first CG resource associated with the first SSB.

The method for the terminal device to determine whether the CG resource is valid includes one or more of: an SSB is present that exceeds the pre-configured threshold and is configured with the CG resource; or the first timer expires or in the non-running state. In the embodiment, during a running time of the first timer, the terminal device may not use a CG resource corresponding to a same HARQ process for new data transmission. That is, during the running time of the first timer, the terminal device may not use the CG resource corresponding to the first HARQ process for new data transmission. New data transmission refers to an initial transmission of any data and is relative to data retransmission.

At operation S402, the terminal device retransmits the first data to the network device using the CG resource associated with the first SSB.

In an embodiment, after the terminal device initially transmits the first data using the first CG resource associated with the first SSB, if the first data is required to be retransmitted, the terminal device may retransmit the first data to the network device using the CG resource associated with the first SSB. Specifically, assuming that the HARQ process corresponding to the first CG resource is the first HARQ process, the terminal device may retransmit the first data to the network device using a second CG resource corresponding to the first HARQ process in the CG resources associated with the first SSB.

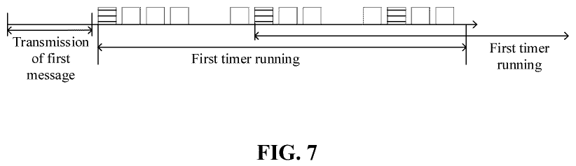

In an embodiment, the terminal device may start the first timer for the first HARQ process, and during the running time of the first timer, the first data is retransmitted to the network device using the second CG resource associated with the first SSB. For example, in the schematic diagram of data transmission illustrated in FIG. 7, the terminal device triggers the CG-SDT process when the trigger condition for the SDT is satisfied. That is, the terminal device transmits the first message after triggering the CG-SDT. After the terminal device successfully transmits the first message, the terminal device starts the first timer when the first CG resource associated with the first SSB is first selected for uplink data transmission.

In an embodiment, an occasion for starting the first timer includes at least one of: an occasion at a starting symbol of the second CG resource associated with the first SSB; an occasion at an ending symbol of the second CG resource associated with the first SSB; or an occasion at a first Physical Downlink Control Channel (PDCCH) for monitoring after completing uplink data transmission using the second CG resource associated with the first SSB. That is, if the terminal device transmits uplink data using the second CG resource associated with the first SSB, the terminal device may start the first timer at the starting symbol of the second CG resource associated with the first SSB. If the terminal device transmits the uplink data using the second CG resource associated with the first SSB, the terminal device may start the first timer at the ending symbol of the second CG resource associated with the first SSB. If the terminal device transmits the uplink data using the second CG resource associated with the first SSB, the terminal device may start the first timer at the first PDCCH for monitoring after completing uplink data transmission using the second CG resource associated with the first SSB.

In an embodiment, after the terminal device starts the first timer, during the running time of the first timer: the terminal device starts a second timer after completing an initial transmission of the first data using the first CG resource associated with the first SSB, and the terminal device starts the second timer after completing each data transmission using the second CG resource associated with the first SSB. When the second timer expires, the terminal device may retransmit the first data to the network device using the second CG resource associated with the first SSB. That is, when the second timer expires during the running time of the first timer, the terminal device may retransmit the first data to the network device using the second CG resource associated with the first SSB.

In an embodiment, the resources used by the terminal device for retransmitting the first data are all the second CG resource associated with the first SSB. That is, assuming that the terminal device transmits the first data to the network device using the first CG resource corresponding to the first HARQ process in the CG resources associated with the first SSB, the terminal device always retransmits the first data to the network device using the second CG resource associated with the first SSB in a subsequent data retransmission process of the first data, and a HARQ process corresponding to the second CG resource is the first HARQ process.

In the embodiment of the disclosure, the terminal device may retransmit the first data using the CG resource for the initial transmission of the first data, which can improve the reliability of the data retransmission.

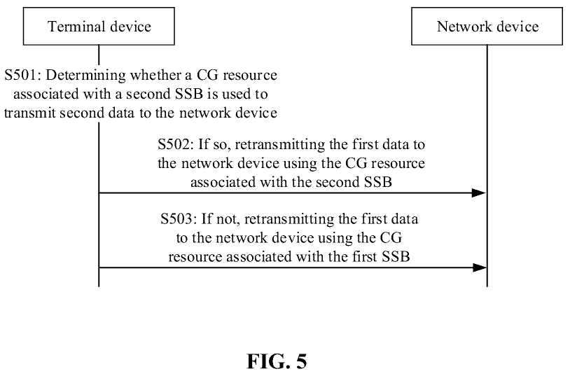

With reference to FIG. 5, FIG. 5 is a flowchart illustrating a method for data transmission according to yet another embodiment of the disclosure, which is applied to the above-mentioned exemplary communication system. The method includes the following operations.

At operation S501, a terminal device determines whether a CG resource associated with a second SSB is used to transmit second data to a network device.

For example, in the CG-SDT process, assuming that the terminal device transmits the first data to the network device using a first CG resource corresponding to a first HARQ process in CG resources associated with the first SSB, and if the transmission of the first data fails, the terminal device may retransmit the first data.

In the embodiment of the disclosure, the terminal device does not need to re-evaluate the SSB when retransmitting the first data, that is, the terminal device does not need to determine whether an SSB is present that satisfies the RSRP threshold and is configured with the CG resource. Specifically, before automatically retransmitting the first data, the terminal device may determine whether the CG resource associated with the second SSB is use to transmit the second data, and if so, the CG resource associated with the second SSB is used to retransmit the first data to the network device; if not, the terminal device may retransmit the first data to the network device using the CG resource associated with the first SSB.

In an embodiment, the terminal device in the RRC_INACTIVE state may trigger the CG-SDT process when the trigger condition for the SDT is satisfied. That is, the terminal device may use the first CG resource associated with the first SSB to transmit the first data to the network device when the trigger condition for the SDT is satisfied. The first SSB refers to an SSB that exceeds a pre-configured threshold and is configured with a CG resource.

Specifically, the terminal device in the RRC_INACTIVE state triggers the CG-SDT process when the trigger condition for the SDT is satisfied. The trigger condition for SDT includes one or more of: to-be-transmitted data belonging to a RB that is allowed to trigger the SDT, and a data amount of the to-be-transmitted data is less than or equal to a data amount threshold configured by a network; a RSRP measurement result is greater than or equal to a pre-configured threshold; a CG resource is present on a carrier for transmitting to-be-transmitted data and a CG resource is present on an SSB for transmitting the to-be-transmitted data; or a TA is a valid TA. The to-be-transmitted data at least includes the first data. Illustratively, when a TA timer (also referred to as a time alignment timer, or TAT for short) is running and/or a change in the RSRP does not exceed the pre-configured threshold, it indicates that the TA is valid.

Further, after the terminal device triggers the CG-SDT, the terminal device may transmit a first message using a CG resource or a dynamic resource scheduled by a network. The first message includes one or more of: an RRC message (e.g., an RRC Resume Request message), terminal data (e.g., user plane data and/or control plane data), or a MAC CE (e.g., a BSR MAC CE), etc.

Further, after the first message is successfully transmitted, in response to a present of to-be-transmitted uplink data, the terminal device may select a valid CG resource for uplink data transmission. Illustratively, the to-be-transmitted uplink data may include the first data. Assuming that the valid CG resource is the first CG resource associated with the first SSB, the terminal device may transmit first data to the network device using the first CG resource associated with the first SSB after the trigger condition for the SDT is satisfied and a transmission of the first message is completed. Optionally, the terminal device may further determine that a first timer for a HARQ process corresponding to the first CG resource associated with the first SSB expires or in a non-running state. That is, after the trigger condition for the SDT is satisfied and the transmission of the first message is completed, if the first timer for the HARQ process corresponding to the first CG resource associated with the first SSB expires or in a non-running state, the terminal device transmits the first data to the network device using the first CG resource associated with the first SSB.

The method for the terminal device to determine whether the CG resource is valid includes one or more of: an SSB is present that exceeds the pre-configured threshold and is configured with the CG resource; or the first timer expires or in the non-running state. In the embodiment, during a running time of the first timer, the terminal device may not use the CG resource corresponding to a same HARQ process for new data transmission. That is, during the running time of the first timer, the terminal device may not use the CG resource corresponding to the first HARQ process for new data transmission. New data transmission refers to the initial transmission of any data and is relative to data retransmission.

At operation S502, if the CG resource associated with the second SSB is used to transmit the second data to the network device, the terminal device retransmits the first data to the network device using the CG resource associated with the second SSB.

In an embodiment, assuming that the terminal device transmits the second data to the network device using a third CG resource corresponding to a second HARQ process in the CG resources associated with the second SSB, the terminal device may retransmit the first data to the network device using a second CG resource corresponding to the second HARQ process in the CG resources associated with the second SSB when retransmitting the first data.

In an embodiment, the terminal device may start the first timer for the first HARQ process, and during the running time of the first timer, the terminal device retransmits the first data to the network device using the second CG resource corresponding to the first HARQ process in the CG resources associated with the second SSB. For example, in the schematic diagram of data transmission illustrated in FIG. 7, the terminal device triggers the CG-SDT process when the trigger condition for the SDT is satisfied. That is, the terminal device transmits the first message after triggering the CG-SDT. After the terminal device successfully transmits the first message, the terminal device starts the first timer when the first CG resource associated with the first SSB is first selected for uplink data transmission.

In an embodiment, an occasion for starting the first timer includes at least one of: an occasion at a starting symbol of the second CG resource associated with the second SSB; an occasion at an ending symbol of the second CG resource associated with the second SSB; or an occasion at a first PDCCH for monitoring after completing uplink data transmission using the second CG resource associated with the second SSB. That is, if the terminal device transmits uplink data using the second CG resource associated with the second SSB, the terminal device may start the first timer at the starting symbol of the second CG resource associated with the second SSB. If the terminal device transmits the uplink data using the second CG resource associated with the second SSB, the terminal device may start the first timer at the ending symbol of the second CG resource associated with the second SSB. If the terminal device transmits the uplink data using the second CG resource associated with the second SSB, the terminal device may start the first timer at the first PDCCH for monitoring after completing uplink data transmission using the second CG resource associated with the second SSB.

In an embodiment, after the terminal device starts the first timer, during the running time of the first timer: the terminal device starts a second timer after completing an initial transmission of the first data using the first CG resource associated with the first SSB, and the terminal device starts the second timer after completing each data transmission using the second CG resource associated with the second SSB. When the second timer expires, the terminal device may retransmit the first data to the network device using the second CG resource associated with the second SSB. That is, when the second timer expires during the running time of the first timer, the terminal device may retransmit the first data to the network device using the second CG resource associated with the second SSB.

At operation S503, if no CG resource associated with the second SSB is used to transmit the second data to the network device, the terminal device retransmits the first data to the network device using the CG resource associated with the first SSB.

In an embodiment, assuming that the terminal device transmits the first data to the network device using the first CG resource associated with the first SSB and the terminal device does not use the CG resource associated with second SSB to transmit the second data to the network device before retransmitting the first data, the terminal device may retransmit the first data to the network device using the second CG resource corresponding to the first HARQ process in the CG resources associated with the first SSB when retransmitting the first data.

In an embodiment, the terminal device may start the first timer for the first HARQ process, and during the running time of the first timer, the terminal device retransmits the first data to the network device using the second CG resource associated with the first SSB. For example, in the schematic diagram of data transmission illustrated in FIG. 7, the terminal device triggers the CG-SDT process when the trigger condition for the SDT is satisfied. That is, the terminal device transmits the first message after triggering the CG-SDT. After the terminal device successfully transmits the first message, the terminal device starts the first timer when the first CG resource associated with the first SSB is first selected for uplink data transmission.

In an embodiment, an occasion for starting the first timer includes at least one of: an occasion at a starting symbol of the second CG resource associated with the first SSB; an occasion at an ending symbol of the second CG resource associated with the first SSB; or an occasion at a first PDCCH for monitoring after completing uplink data transmission using the second CG resource associated with the first SSB. That is, if the terminal device transmits uplink data using the second CG resource associated with the first SSB, the terminal device may start the first timer at the starting symbol of the second CG resource associated with the first SSB. If the terminal device transmits the uplink data using the second CG resource associated with the first SSB, the terminal device may start the first timer at the ending symbol of the second CG resource associated with the first SSB. If the terminal device transmits the uplink data using the second CG resource associated with the first SSB, the terminal device may start the first timer at the first PDCCH for monitoring after completing uplink data transmission using the second CG resource associated with the first SSB.

In an embodiment, after the terminal device starts the first timer, during the running time of the first timer: the terminal device starts a second timer after completing an initial transmission of the first data using the first CG resource associated with the first SSB, and the terminal device starts the second timer after completing each data transmission using the second CG resource associated with the first SSB. When the second timer expires, the terminal device may retransmit the first data to the network device using the second CG resource associated with the first SSB. That is, when the second timer expires during the running time of the first timer, the terminal device may retransmit the first data to the network device using the second CG resource associated with the first SSB.

In the embodiment of the disclosure, the terminal device may use an SSB, corresponding to another HARQ process and selected for new data transmission, as the SSB for data retransmission, so that the terminal device retransmits the first data to the network device using the second CG resource associated with this SSB, thereby improving the reliability of data retransmission.

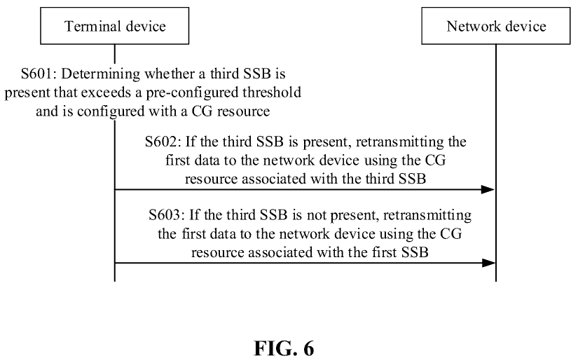

With reference to FIG. 6, FIG. 6 is a flowchart illustrating a method for data transmission according to still another embodiment of the disclosure, which is applied to the above-mentioned exemplary communication system. The method includes the following operations.

At operation S601, the terminal device determines whether a third SSB is present that exceeds a pre-configured threshold and is configured with a CG resource.

For example, in the CG-SDT process, assuming that the terminal device transmits the first data to the network device using the first CG resource corresponding to a first HARQ process in the CG resources associated with the first SSB, and if the transmission of the first data fails, the terminal device may retransmit the first data. The terminal device re-evaluates the SSB when retransmitting the first data. That is, the terminal device determines whether an SSB is present that that exceeds a pre-configured threshold and is configured with a CG resource. In response to a presence of the SSB, the first data is retransmitted to the network device using the CG resource associated with the SSB; and in response to an absence of the SSB, the first data is retransmitted to the network device using the CG resource associated with the first SSB. In the embodiment, since the terminal device re-evaluates the SSB when retransmitting the first data, the determined third SSB that satisfies the RSRP threshold and is configured with the CG resource may be or may not be the first SSB. That is, the third SSB may the same as or different from the first SSB.

In an embodiment, the terminal device in the RRC_INACTIVE state may trigger the CG-SDT process when the trigger condition for the SDT is satisfied. That is, the terminal device may transmit the first data to the network device using the first CG resource associated with the first SSB when the trigger condition for the SDT is satisfied. The first SSB refers to an SSB that exceeds a pre-configured threshold and is configured with a CG resource.

Specifically, the terminal device in the RRC_INACTIVE state triggers the CG-SDT process when the trigger condition for the SDT is satisfied. The trigger condition for SDT includes one or more of: to-be-transmitted data belonging to a RB that is allowed to trigger the SDT, and a data amount of the to-be-transmitted data is less than or equal to a data amount threshold configured by a network; a RSRP measurement result is greater than or equal to a pre-configured threshold; a CG resource is present on a carrier for transmitting to-be-transmitted data and a CG resource is present on an SSB for transmitting the to-be-transmitted data; or a TA is a valid TA. The to-be-transmitted data at least includes the first data. Illustratively, when a TA timer (also referred to as a time alignment timer, or TAT for short) is running and/or a change in the RSRP does not exceed the pre-configured threshold, it indicates that the TA is valid.

Further, after the terminal device triggers the CG-SDT, the terminal device may transmit a first message using a CG resource or a dynamic resource scheduled by a network. The first message includes one or more of: an RRC message (e.g., an RRC Resume Request message), terminal data (e.g., user plane data and/or control plane data), or a MAC CE, (e.g., a BSR MAC CE), etc.

Further, after the first message is successfully transmitted, in response to a present of to-be-transmitted uplink data, the terminal device may select a valid CG resource for uplink data transmission. Illustratively, the to-be-transmitted uplink data may include the first data. Assuming that the valid CG resource is the first CG resource associated with the first SSB, the terminal device may transmit the first data to the network device using the first CG resource associated with the first SSB after the trigger condition for the SDT is satisfied and a transmission of the first message is completed. Optionally, the terminal device may further determine that a first timer for a HARQ process corresponding to the first CG resource associated with the first SSB expires or in a non-running state. That is, after the trigger condition for the SDT is satisfied and the transmission of the first message is completed, if the first timer for the HARQ process corresponding to the first CG resource associated with the first SSB expires or in a non-running state, the terminal device transmits the first data to the network device using the first CG resource associated with the first SSB.

The method for the terminal device to determine whether the CG resource is valid includes one or more of: an SSB is present that exceeds the pre-configured threshold and is configured with the CG resource; or the first timer expires or in the non-running state. In the embodiment, during a running time of the first timer, the terminal device may not use the CG resource corresponding to a same HARQ process for new data transmission. That is, during the running time of the first timer, the terminal device may not use the CG resource corresponding to the first HARQ process for new data transmission. New data transmission refers to the initial transmission of any data and is relative to data retransmission.

At operation S602, if the third SSB exists, the terminal device retransmits the first data to the network device using the CG resource associated with the third SSB.

In an embodiment, after the terminal device determines the third SSB that exceeds the pre-configured threshold and is configured with the CG resource, the terminal device may retransmit the first data to the network device using the CG resource associated with the third SSB.

In an embodiment, assuming that the terminal device transmits the first data to the network device using the first CG resource corresponding to the first HARQ process in CG resources associated with the first SSB, the terminal device may determine the third SSB that exceeds the pre-configured threshold and is configured with the CG resource when retransmitting the first data, and then retransmit the first data to the network device using the second CG resource corresponding to the first HARQ process in CG resources associated with the third SSB.

In an embodiment, the terminal device may start the first timer for the first HARQ process, and during the running time of the first timer, the first data is retransmitted to the network device using the second CG resource corresponding to the first HARQ process in the CG resources associated with the third SSB. For example, in the schematic diagram of data transmission illustrated in FIG. 7, the terminal device triggers the CG-SDT process when the trigger condition for the SDT is satisfied. That is, the terminal device transmits the first message after triggering the CG-SDT. After the terminal device successfully transmits the first message, the terminal device starts the first timer when the first CG resource associated with the first SSB is first selected for uplink data transmission.

In an embodiment, an occasion for starting the first timer includes at least one of: an occasion at a starting symbol of the second CG resource associated with the third SSB; an occasion at an ending symbol of the second CG resource associated with the third SSB; or an occasion at a first PDCCH for monitoring after completing uplink data transmission using the second CG resource associated with the third SSB. That is, if the terminal device transmits uplink data using the second CG resource associated with the third SSB, the terminal device may start the first timer at the starting symbol of the second CG resource associated with the third SSB. If the terminal device transmits the uplink data using the second CG resource associated with the third SSB, the terminal device may start the first timer at the ending symbol of the second CG resource associated with the third SSB. If the terminal device transmits the uplink data using the second CG resource associated with the third SSB, the terminal device may start the first timer at the first PDCCH for monitoring after completing uplink data transmission using the second CG resource associated with the third SSB.

In an embodiment, after the terminal device starts the first timer, during the running time of the first timer: the terminal device starts a second timer after completing an initial transmission of the first data using the first CG resource associated with the first SSB, and the terminal device starts the second timer after completing each data transmission using the second CG resource associated with the third SSB. When the second timer expires, the terminal device may retransmit the first data to the network device using the second CG resource associated with the third SSB. That is, when the second timer expires during the running time of the first timer, the terminal device may retransmit the first data to the network device using the second CG resource associated with the third SSB.

At operation S603, if the third SSB does not exist, the terminal device retransmits the first data to the network device using the CG resource associated with the first SSB, or initiates a random access procedure.

In an embodiment, assuming that the terminal device transmits the first data to the network device using the first CG resource associated with the first SSB and determines that there is no SSB exceeding the pre-configured threshold and configured with the CG resource before retransmitting the first data, the terminal device may retransmit the first data to the network device using the second CG resource corresponding to the first HARQ process in the CG resources associated with the first SSB when the first data is retransmitted or initiate the random access procedure.

In an embodiment, the terminal device may start the first timer for the first HARQ process, and during the running time of the first timer, the terminal device retransmits the first data to the network device using the second CG resource associated with the first SSB. For example, in the schematic diagram of data transmission illustrated in FIG. 7, the terminal device triggers the CG-SDT process when the trigger condition for the SDT is satisfied. That is, the terminal device transmits the first message after triggering the CG-SDT. After the terminal device successfully transmits the first message, the terminal device starts the first timer when the first CG resource associated with the first SSB is first selected for uplink data transmission.

In an embodiment, an occasion for starting the first timer includes at least one of: an occasion at a starting symbol of the second CG resource associated with the first SSB; an occasion at an ending symbol of the second CG resource associated with the first SSB; or an occasion at a first PDCCH for monitoring after completing uplink data transmission using the second CG resource associated with the first SSB. That is, if the terminal device transmits uplink data using the second CG resource associated with the first SSB, the terminal device may start the first timer at the starting symbol of the second CG resource associated with the first SSB. If the terminal device transmits the uplink data using the second CG resource associated with the first SSB, the terminal device may start the first timer at the ending symbol of the second CG resource associated with the first SSB. If the terminal device transmits the uplink data using the second CG resource associated with the first SSB, the terminal device may start the first timer at the first PDCCH for monitoring after completing uplink data transmission using the second CG resource associated with the first SSB.

In an embodiment, after the terminal device starts the first timer, during the running time of the first timer: the terminal device starts a second timer after completing an initial transmission of the first data using the first CG resource associated with the first SSB, and the terminal device starts the second timer after completing each data transmission using the second CG resource associated with the first SSB. When the second timer expires, the terminal device may retransmit the first data to the network device using the second CG resource associated with the first SSB. That is, when the second timer expires during the running time of the first timer, the terminal device may retransmit the first data to the network device using the second CG resource associated with the first SSB.

In the embodiment of the disclosure, the terminal device re-selects the SSB that satisfies the condition, and then retransmits the first data to the network device using the CG resource associated with this SSB, which may improve the reliability of data retransmission.

The solutions in the embodiments of the disclosure are mainly introduced from a perspective of interaction between various network elements. It can be understood that, in order to achieve above functions, the terminal device includes corresponding hardware structures and/or software modules for performing each function. It should be readily apparent to those skilled in the art that the units and algorithm steps of each example described in combination with the embodiments disclosed in the disclosure may be implemented by hardware or a combination of the hardware and computer software. Whether a certain function is implemented in a hardware or software driving hardware form depends on specific applications and design constraints of the technical solutions. Professionals may implement the described functions for each specific application by use of different methods, and such implementation shall fall within the scope of the disclosure.

The embodiments of the disclosure may divide the functional units of the terminal device according to the above method examples, for example, respective functional units may be divided corresponding to respective functions, and two or more functions may also be integrated into a processing unit. The integrated unit may be realized either in a hardware form or in a software program module form. It should be noted that, the division of units in the embodiments of the disclosure is schematic, is only a logical function division, and other division manners may be adopted during a practical implementation.

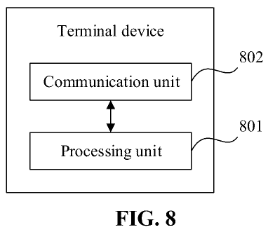

In the case of using integrated units, FIG. 8 illustrates a block diagram of a possible functional unit composition of a terminal device involved in the above embodiments. The terminal device includes a processing unit 801 and a communication unit 802.

The processing unit 801 is configured to determine a target SSB.

The communication unit 802 is configured to retransmit first data to a network device using a CG resource associated with the target SSB.

The processing unit 801 may be a processor or a controller, and the communication unit 802 may be a transceiver, a transceiver circuit, a radio frequency chip and/or the like.

In an implementation, the communication unit 802 is further configured to initially transmit the first data using a first CG resource associated with a first SSB. A HARQ process corresponding to the first CG resource is a first HARQ process.

The processing unit 801 is configured to determine the first SSB as the target SSB.

In an implementation, the processing unit 801 is configured to: in response to second data being transmitted using a CG resource associated with a second SSB before determining the target SSB, determine the second SSB as the target SSB; and in response to no second data being transmitted using the CG resource associated with the second SSB before determining the target SSB, determine a first SSB as the target SSB.

In an implementation, the processing unit 801 is configured to: determine whether a third SSB is present that exceeds a pre-configured threshold and is configured with a CG resource; in response to a presence of the third SSB, determine the third SSB as the target SSB; and in response to an absence of the third SSB, determine a first SSB as the target SSB or initiate a random access procedure.

In an implementation, the processing unit 801 is further configured to start a first timer for the first HARQ process.

The communication unit 802 is configured to retransmit the first data to the network device using a second CG resource corresponding to the first HARQ process in CG resources associated with the target SSB during a running time of the first timer.

In an implementation, an occasion for starting the first timer includes at least one of: an occasion at a starting symbol of the second CG resource; an occasion at an ending symbol of the second CG resource; or an occasion at a first PDCCH for monitoring after completing uplink data transmission using the second CG resource.

In an implementation, the processing unit 801 is further configured to: start a second timer after completing an initial transmission of the first data using the first CG resource associated with the first SSB, and start the second timer after completing each data transmission using the second CG resource associated with the target SSB.

The communication unit 802 is configured to retransmit the first data to the network device using the second CG resource associated with the target SSB when the second timer expires during the running time of the first timer.

In an implementation, the communication unit 802 is further configured to transmit the first data to the network device using a CG resource associated with a first SSB after a trigger condition for SDT is satisfied and a transmission of a first message is completed.

In an implementation, the first SSB refers to an SSB that exceeds a pre-configured threshold and is configured with a CG resource.

In an implementation, the processing unit 801 is further configured to determine that a first timer for a HARQ process corresponding to the first CG resource associated with the first SSB expires or in a non-running state.

In an implementation, the trigger condition for the SDT includes one or more of: to-be-transmitted data belonging to a RB that is allowed to trigger the SDT, and a data amount of the to-be-transmitted data is less than or equal to a data amount threshold configured by a network; a RSRP measurement result is greater than or equal to a pre-configured threshold; a CG resource is present on a carrier for transmitting to-be-transmitted data and a CG resource is present on an SSB for transmitting the to-be-transmitted data; or TA is a valid TA. The to-be-transmitted data at least includes the first data.

In an implementation, the first message is transmitted using a CG resource or a dynamic resource scheduled by a network, and the first message includes one or more of: an RRC message, terminal data, or a MAC CE.

In the embodiment of the disclosure, the processing unit 801 is configured to determine the target SSB, and the communication unit 802 is configured to retransmit the first data to the network device using the CG resource associated with the determined target SSB, which may improve the reliability of data retransmission.

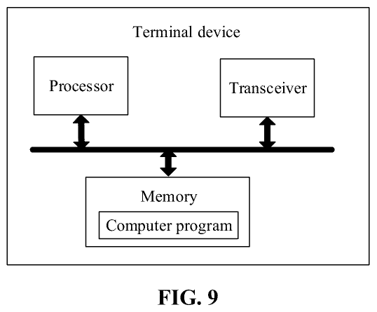

When the processing unit 801 is a processor and the communication unit 802 is a transceiver, the terminal device in the embodiment of the disclosure may be a terminal device illustrated in FIG. 9.

An embodiment of the disclosure further provides a computer-readable storage medium, which stores a computer program. The computer program causes a computer to perform part or all of the operations executed by the terminal device in the method embodiments described above.

An embodiment of the disclosure further provides a computer program product. The computer program product includes a non-transitory computer-readable storage medium storing a computer program, and the computer program is executable to enable a computer to perform part or all of the operations executed by the terminal device in the method embodiments described above. The computer program product may be a software installation package.

It can be seen that the embodiments of the disclosure may improve the reliability of the data retransmission by determining the target SSB for data retransmission and then retransmitting the first data to the network device using the CG resource associated with the determined target SSB.

The steps of the method or algorithm described in the embodiments of the disclosure may be implemented in the form of hardware or in the form of software instructions executed by the processor. The software instructions may be composed of corresponding software modules that may be stored in a Random Access Memory (RAM), a flash memory, a Read Only Memory (ROM), an Erasable Programmable ROM (EPROM), an Electrically EPROM (EEPROM), a register, a hard disk, a mobile hard disk, a read only disk (CD-ROM), or any other form of storage medium well known in the art. An exemplary storage medium is coupled to a processor to enable the processor to read information from the storage medium and write information into the storage medium. The storage medium may also be a component of the processor. The processor and storage medium may be in an Application Specific Integrated Circuit (ASIC). In addition, the ASIC may be located in an access network device, a target network device, or a core network device. The processor and the storage medium may also exist as discrete components in the access network device, the target network device, or the core network device.

Those skilled in the art should realize that the functions described in the embodiments of the disclosure may fully or partially implemented by software, hardware, firmware or any combination thereof in one or more of above examples. When implemented in software, the functions may be fully or partially implemented in the form of a computer program product. The computer program product includes one or more computer instructions. When the computer program instructions are loaded and executed on a computer, all or part of the processes or functions according to embodiments of the disclosure are generated. The computer may be a general computer, a specialized computer, a computer network, or other programmable devices. The computer instructions may be stored in a computer-readable storage medium, or be transmitted from one computer-readable storage medium to another computer-readable storage medium. For example, the computer instructions may be transmitted from one website site, computer, server, or data center to another website site, computer, server, or data center through a wired (e.g., a coaxial cable, an optical fiber, a digital subscriber line (DSL)) or a wireless (e.g., infrared, wireless, microwave, etc.) manner. The computer-readable storage medium may be any available medium that a computer can access, or may be a data storage device such as a server or a data center that contains one or more available media. The available medium may be a magnetic medium (such as, a floppy disk, a hard drive, a magnetic tape), an optical medium (e.g., a Digital Video Disc (DVD)), or a semiconductor medium (e.g., a solid state disk (SSD)) and the like.

The specific implementations described above provide a further detailed explanation of the purpose, the technical solutions and the beneficial effects of the embodiments of the disclosure. It should be understood that the above are only the specific implementations of the embodiments of the disclosure, and are not intended to limit the scope of protection of the embodiments of the disclosure. Any modification, equivalent replacement or improvement, made on the basis of the technical solutions of the embodiments of the disclosure should fall within the scope of protection of the embodiments of the disclosure.

1. A method for data transmission, comprising:
determining a target Synchronization Signal Block (SSB); and
retransmitting first data to a network device using a Configured Grant (CG) resource associated with the target SSB.

2. The method of claim 1, further comprising:
initially transmitting the first data using a first CG resource associated with a first SSB, wherein a Hybrid Automatic Repeat reQuest (HARQ) process corresponding to the first CG resource is a first HARQ process,
wherein determining the target SSB comprises:
determining the first SSB as the target SSB.

3. The method of claim 1, wherein determining the target SSB comprises:
when second data is transmitted using a CG resource associated with a second SSB before determining the target SSB, determining the second SSB as the target SSB; otherwise, determining a first SSB as the target SSB;
or
determining whether a third SSB is present that exceeds a pre-configured threshold and is configured with a CG resource; when the third SSB is present, determining the third SSB as the target SSB; and when the third SSB is not present, determining a first SSB as the target SSB or initiating a random access procedure.

4. The method of claim 2, further comprising:
starting a first timer for the first HARQ process,
wherein retransmitting the first data to the network device using the CG resource associated with the target SSB comprises:
retransmitting, during a running time of the first timer, the first data to the network device using a second CG resource corresponding to the first HARQ process in CG resources associated with the target SSB.

5. The method of claim 4, wherein an occasion for starting the first timer comprises at least one of:
an occasion at a starting symbol of the second CG resource;
an occasion at an ending symbol of the second CG resource; or
an occasion at a first Physical Downlink Control Channel (PDCCH) for monitoring after completing uplink data transmission using the second CG resource.

6. The method of claim 4, further comprising:
starting a second timer after completing an initial transmission of the first data using the first CG resource associated with the first SSB, and starting the second timer after completing each data transmission using the second CG resource associated with the target SSB,
wherein retransmitting, during the running time of the first timer, the first data to the network device using the second CG resource corresponding to the first HARQ process in the CG resources associated with the target SSB comprises:
when the second timer expires during the running time of the first timer, retransmitting the first data to the network device using the second CG resource associated with the target SSB.

7. The method of claim 1, further comprising:
after a trigger condition for Small Data Transmission (SDT) is satisfied and a transmission of a first message is completed,
transmitting the first data to the network device using a first CG resource associated with a first SSB.

8. The method of claim 7, wherein the first SSB refers to an SSB that exceeds a pre-configured threshold and is configured with a CG resource.

9. The method of claim 7, further comprising:
determining that a first timer for a Hybrid Automatic Repeat reQuest (HARQ) process corresponding to the first CG resource associated with the first SSB expires or in a non-running state.

10. A terminal device, comprising a processor, a memory and a transceiver, wherein the processor is coupled to the memory and the transceiver, and wherein
the memory is configured to store instructions; and
the processor is configured to: determine a target Synchronization Signal Block (SSB), and control the transceiver to retransmit first data to a network device using a Configured Grant (CG) resource associated with the target SSB.

11. The terminal device of claim 10, wherein the processor is further configured to:
control the transceiver to initially transmit the first data using a first CG resource associated with a first SSB, wherein a Hybrid Automatic Repeat reQuest (HARQ) process corresponding to the first CG resource is a first HARQ process; and
determine the first SSB as the target SSB.

12. The terminal device of claim 10, wherein the processor is further configured to:
when second data is transmitted using a CG resource associated with a second SSB before determining the target SSB, determine the second SSB as the target SSB; otherwise, determine a first SSB as the target SSB;
or
determine whether a third SSB is present that exceeds a pre-configured threshold and is configured with a CG resource; when the third SSB is present, determine the third SSB as the target SSB; and when the third SSB is not present, determine a first SSB as the target SSB or initiate a random access procedure.

13. The terminal device of claim 11, wherein the processor is further configured to:
start a first timer for the first HARQ process; and
control the transceiver to retransmit, during a running time of the first timer, the first data to the network device using a second CG resource corresponding to the first HARQ process in CG resources associated with the target SSB.

14. The terminal device of claim 13, wherein an occasion for starting the first timer comprises at least one of:
an occasion at a starting symbol of the second CG resource;
an occasion at an ending symbol of the second CG resource; or
an occasion at a first Physical Downlink Control Channel (PDCCH) for monitoring after completing uplink data transmission using the second CG resource.

15. The terminal device of claim 13, wherein the processor is further configured to:
start a second timer after completing an initial transmission of the first data using the first CG resource associated with the first SSB, and start the second timer after completing each data transmission using the second CG resource associated with the target SSB; and
when the second timer expires during the running time of the first timer, control the transceiver to retransmit the first data to the network device using the second CG resource associated with the target SSB.

16. The terminal device of claim 10, wherein the processor is further configured to:
after a trigger condition for Small Data Transmission (SDT) is satisfied and a transmission of a first message is completed,
control the transceiver to transmit the first data to the network device using a first CG resource associated with a first SSB.

17. The terminal device of claim 16, wherein the trigger condition for the SDT comprises one or more of:
to-be-transmitted data belonging to a Radio Bearer (RB) that is allowed to trigger the SDT, and a data amount of the to-be-transmitted data is less than or equal to a data amount threshold configured by a network;
a Reference Signal Received Power (RSRP) measurement result is greater than or equal to a pre-configured threshold;
a CG resource is present on a carrier for transmitting to-be-transmitted data and a CG resource is present on an SSB for transmitting the to-be-transmitted data; or
Timing Advance (TA) is a valid TA,
wherein the to-be-transmitted data at least comprises the first data.

18. The terminal device of claim 16, wherein the first message is transmitted using a CG resource or a dynamic resource scheduled by a network, and the first message comprises one or more of: a Radio Resource Control (RRC) message, terminal data, or a Medium Access Control Control Element (MAC CE).

19. A non-transitory computer storage medium having stored thereon computer programs or instructions that, when executed by a processor, cause the processor to perform operations comprising:
determining a target Synchronization Signal Block (SSB); and
retransmitting first data to a network device using a Configured Grant (CG) resource associated with the target SSB.

20. The non-transitory computer storage medium of claim 19, wherein the operations further comprise:
initially transmitting the first data using a first CG resource associated with a first SSB, wherein a Hybrid Automatic Repeat reQuest (HARQ) process corresponding to the first CG resource is a first HARQ process,
wherein determining the target SSB comprises:
determining the first SSB as the target SSB.
